(19) United States
(12) Patent Application Publication
(10) Pub. No.: US 2017/0085828 A1
(43) Pub. Date: Mar. 23, 2017

(54) MOUNT FOR TELEVISIONS AND THE LIKE

(71) Applicant: Suncraft Solutions, Inc., Pomona, CA (US)

(72) Inventors: Donald Shen, Guangzhou (CN); Michael Roach, Libertyville, IL (US)

(21) Appl. No.: 15/272,066

(22) Filed: Sep. 21, 2016

Related U.S. Application Data
(60) Provisional application No. 62/221,884, filed on Sep. 22, 2015.

(51) Int. Cl. H04N 5/64; F16M 13/02; A47B 97/00

(52) U.S. Cl. CPC H04N 5/64; A47B 97/001; F16M 13/02; F16M 2200/06

(57) ABSTRACT

A mount for a television or other media device is able to be extended from a mounting wall over a relatively large range. The mount can also be tilted from side to side and up and down, so that the television may be readily viewable from multiple locations within a room. The mount is sturdy, and may be provided with decorative paneling. In an embodiment, the mount includes a first beam; a second beam; plural first members connected rotatably to the first beam; plural second members connected rotatably to the second beam; a third member connected rotatably to a first pair of the first and second members; a fourth member connected rotatably to a second pair of the first and second members; and a plate connected rotatably to the third and fourth members.

### PRIORITY

This application claims priority to and the benefit of U.S. Provisional Application No. 62/221,884, filed Sep. 22, 2015, the entire contents of which are incorporated herein by reference and relied upon.

### BACKGROUND

The present disclosure relates to audio-visual equipment and in particular to television mounting equipment.

Television mounts that do not provide an ability to rotate the televisions are limited to projecting the television image straight out from the wall. Television mounts that do provide the ability to rotate the television are typically bulky and consume much space. Moreover, certain new televisions are curved to provide enhanced viewing. Curved televisions provide mounting challenges and in many instances benefit from a mount that can rotate.

An improved rotatable mount for televisions and other video screens is needed accordingly.

### SUMMARY

A mount for televisions and the like is provided herein. The mount is hinged or includes members rotatable with respect to each other, such that the television or other type of video screen supported by the mount can be tilted in a large variety of ways relative to a wall or other structure to which the television or other type of video screen is mounted. The mount includes arms that may be folded so that the television or other type of video screen resides very close to the mounting wall or other structure. Or, one of the arms may be unfolded, while the other arm remains folded, so as to tilt the television or other type of video screen about a vertical axis in a desired direction. Still further, both of the arms may be unfolded, so that the television or other type of video screen is spaced out from a wall or other mounting structure. Each arm may be individually set to be (i) completely folded, (ii) completely unfolded, or (iii) unfolded to any desired degree between completely folded and completely unfolded. The portion of the mount that is attached, e.g., bolted to the television or other type of video screen may be configured to tilt about a horizontal axis, providing an overall highly flexible mount having a thin profile.

In light of the technical features set forth herein, and without limitation, in a first aspect, a mount for televisions and the like includes a first beam; a second beam; plural first members connected rotatably to the first beam; plural second members connected rotatably to the second beam; a third member connected rotatably to a first pair of the first and second members; a fourth member connected rotatably to a second pair of the first and second members; and a plate connected rotatably to the third and fourth members.

In a second aspect, which may be used in combination with any other aspect described herein unless specified otherwise, at least one of the rotatable connections is a hinged connection.

In a third aspect, which may be used in combination with any other aspect described herein unless specified otherwise, at least one of the members is covered with a panel.

In a fourth aspect, which may be used in combination with any other aspect described herein unless specified otherwise, the mount includes an attachment flange connected to the plate, the attachment flange providing at least one hole for attachment to the television or the like.

In a fifth aspect, which may be used with the fourth aspect in combination with any other aspect described herein unless specified otherwise, the mount includes differently sized attachment flanges for differently sized televisions and the like.

In a sixth aspect, which may be used with the fourth aspect in combination with any other aspect described herein unless specified otherwise, the attachment flange is connected rotatably to the plate.

In a seventh aspect, which may be used with the sixth aspect in combination with any other aspect described herein unless specified otherwise, when the mount is in use, the rotatable connections of the first, second, third and fourth members and the plate are about at least substantially vertical axes, while the rotatable connection of the attachment flange is about an at least substantially horizontal axis.

In an eighth aspect, which may be used in combination with any other aspect described herein unless specified otherwise, the mount includes a first hinge rod extending between the first and second members of the first pair, the third member connected to the first hinge rod, the first hinge rod rotatable with respect to the first and second members.

In a ninth aspect, which may be used with the eighth aspect in combination with any other aspect described herein unless specified otherwise, the mount includes a restraining member for restraining movement of the third member, the restraining member extending between the first and second members of the first pair.

In a tenth aspect, which may be used with the eighth aspect in combination with any other aspect described herein unless specified otherwise, the mount includes a second hinge rod extending between the first and second members of the second pair, the fourth member connected to the second hinge rod, the second hinge rod rotatable with respect to the second pair of the first and second members.

In an eleventh aspect, which may be used in combination with any other aspect described herein unless specified otherwise, the mount includes at least one support beam extending between the first and second beams.

In a twelfth aspect, which may be used in combination with any other aspect described herein unless specified otherwise, when the mount is in use, the plural first members angle downwardly from the first beam.

In a thirteenth aspect, which may be used with the twelfth aspect in combination with any other aspect described herein unless specified otherwise, when the mount is in use, the plural second members angle upwardly from the second beam.

In a fourteenth aspect, which may be used with the thirteenth aspect in combination with any other aspect described herein unless specified otherwise, the angles provided by the plural first members and the plural second members place the third and fourth members at least substantially equally between the first and second beams.

In a fifteenth aspect, which may be used in combination with any other aspect described herein unless specified otherwise, a mount for televisions and the like includes a first beam; a second beam; a first member connected rotatably to the first beam and angled towards the second beam; a second member connected rotatably to the second beam and angled towards the first beam; a third member connected rotatably to the first and second members, the angles of the first and second members placing the third member at least substantially equally between the first and second beams; and a plate connected rotatably to the third member.

In a sixteenth aspect, which may be used with the fifteenth aspect in combination with any other aspect described herein unless specified otherwise, the mount includes an attachment flange connected to the plate, the attachment flange providing at least one hole for attachment to the television or the like.

In a seventeenth aspect, which may be used with the fifteenth aspect in combination with any other aspect described herein unless specified otherwise, the mount includes at least one support beam extending between the first and second beams.

In an eighteenth aspect, which may be used with the fifteenth aspect in combination with any other aspect described herein unless specified otherwise, the mount includes a hinge rod extending between the first and second members, the third member connected to the hinge rod, the hinge rod rotatable with respect to the first and second members.

In a nineteenth aspect, which may be used with the eighteenth aspect in combination with any other aspect described herein unless specified otherwise, the mount includes a restraining member for restraining movement of the third member, the restraining member extending between the first and second members.

In a twentieth aspect, which may be used in combination with any other aspect described herein unless specified otherwise, a mount for televisions and the like includes a first beam; a second beam; a plate; a first arm in rotatable communication with (i) the first and second beams and (ii) the plate, the first arm including a first internal hinge; and a second arm in rotatable communication with (i) the first and second beams and (ii) the plate, the second arm including a second internal hinge.

In a twenty-first aspect, any of the features, functionality and alternatives described in connection with any one or more of FIGS. 1 to 6C may be combined with any of the features, functionality and alternatives described in connection with any of the other one or more of FIGS. 1 to 6C.

It is accordingly an advantage of the present disclosure to provide a thin, e.g., less than 1.5 inch (38.1 millimeters (“ml”)) thick, articulating television mount.

It is another advantage of the present disclosure to provide strength and support for televisions, for example, up to 150 lbs, and 40 to 90 inches (100 centimeters (“cm”) to 228 cm) diagonal measurement, having straight or curved screens.

It is a further advantage of the present disclosure to provide a television mount having an aesthetic fit and finish.

It is yet another advantage to provide a television mount that is relatively quick and simple to install.

Still further, it is an advantage of the present disclosure to provide a television mount that may reside flat against a wall or other mounting structure, extend out from the wall or other mounting structure, or be angled in many different desirable ways relative to the wall or other mounting structure.

It should be appreciated that not all of the embodiments discussed herein have to have all of the advantages listed herein. Additional features and advantages are described herein, and will be apparent from, the following Detailed Description and the figures.

### BRIEF DESCRIPTION OF THE FIGURES

FIG. 1 is a perspective view illustrating one embodiment of a television mount of the present disclosure in a flat form, e.g., when pulled out of its package.

FIGS. 2A and 2B are perspective views of the mount of FIG. 1 illustrating the mount in different positions, respectively.

FIGS. 3A to 3E are perspective views illustrating another embodiment of a television mount of the present disclosure.

FIGS. 4A and 4B are perspective views illustrating how a particular mount of the present disclosure can be provided with decorative paneling.

FIG. 5 is a perspective view further illustrating an example of the paneling.

FIGS. 6A to 6C are front elevation, top, and side views respectively, illustrating one set of example dimensions and angular movement ranges for the mounts of the present disclosure.

### DETAILED DESCRIPTION

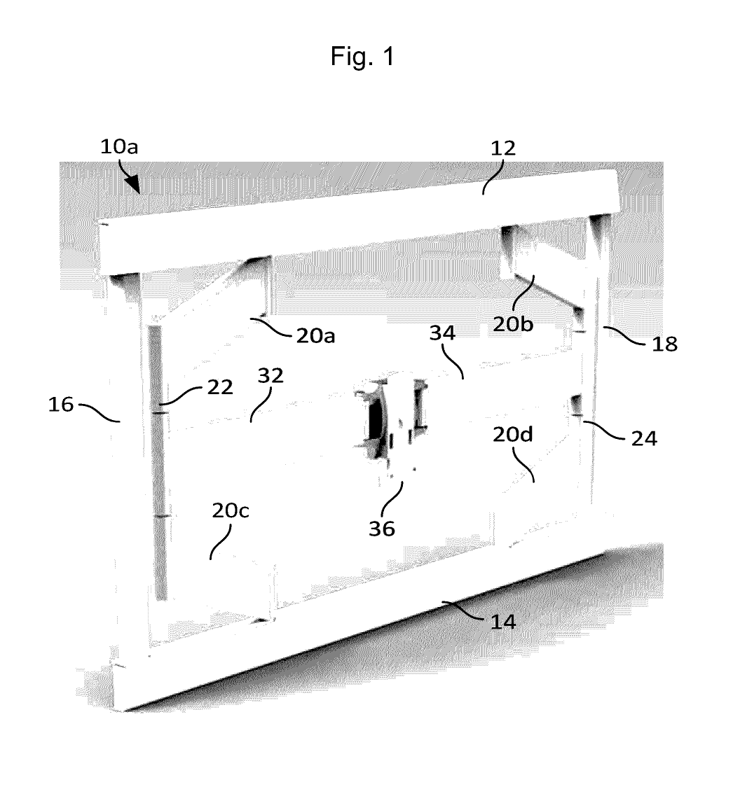

FIG. 1 illustrates a television mount 10a in a flat form, e.g., when pulled out of a package. Mount 10a can be made of any metal, e.g., aluminum, steel, stainless steel, and alloys thereof, plastic and/or wood. Mount 10a includes a top beam 12, bottom beam 14, side beams 16 and 18, angled members 20a to 20d, and a middle lateral members 32 and 34. Side beams 16 and 18 are attached to or formed with top beam 12 and bottom beam 14 to form a solid square or rectangular structure. Angled members 20a and 20b are connected hingedly to top beam 12, while angled members 20c and 20d are connected hingedly to bottom beam 14.

The distal ends of angled members 20a and 20c are connected hingedly to hinge 22, while the distal ends of angled members 20b and 20d are connected hingedly to hinge 24. Lateral member 32 is connected hingedly to hinge 22, while lateral member 34 is connected hingedly to hinge 24. The distal ends of lateral members 32 and 34 are connected hingedly to a hinge plate 36.

Members 20a, 20c and 32 may be said to form a first arm connected rotatably to (i) top beam 12 and bottom beam 14 and (ii) hinge plate 36, where the first arm includes an internal hinge between members 20a, 20c and member 32. Members 20b, 20d and 34 may be said to form a second arm connected rotatably to (i) top beam 12 and bottom beam 14 and (ii) hinge plate 36, where the second arm includes an internal hinge between members 20b, 20d and member 34. The internal hinges as illustrated include a first rod extending rotatably between members 20a and 20b and a second rod extending rotatably between members 20b and 20d. Member 32 extends from the first rod as illustrated, while member 34 extends from the second rod.

It should also be appreciated that in one embodiment when mount 10a (and each of the mounts described herein in one embodiment) is in use, angled members 20a and 20b angle down from top beam 12, while angled members 20c and 20d angle up from bottom beam 14. The angles of members 20a to 20d enable lateral members 32 and 34 to reside at least substantially along a midline between top beam 12 and bottom beam 14.

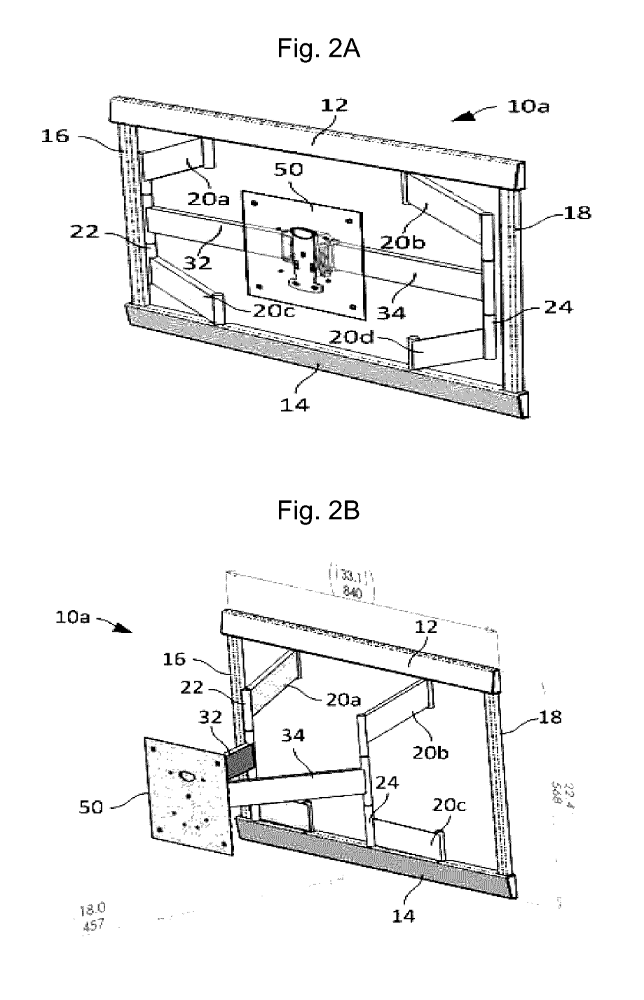

FIGS. 2A and 2B illustrate mount 10a in a flat-use or as packaged state (FIG. 2A) and a non-flat use state (FIG. 2B). Mount 10a is also illustrated as having a television attachment flange 50, which can be part of mount 10a or part of a television (not illustrated). Attachment flange 50 can be attached to or formed with hinge plate 36 in various embodiments. FIG. 2A illustrates that when mount 10a is in a flat-use or as packaged position, angled members 20a to 20d may fit within side beams 16 and 18. FIG. 2B illustrates that when in non-flat use, angled members 20a to 20d hinge outwardly from upper beam 12 and lower beam 14.

FIG. 2B also illustrates that lateral members 32 and 34 hinge out from hinges 22 and 24, respectively in a non-flat use state. The arrangement of mount 10a enables the user to pull the television out from a wall or other mounting structure to which mount 10a is mounted a desired and adjustable distance. The distance can be very small relative to competitive mounts, e.g., on the order of 1.5 inches (38 millimeters (“mm”). On the other end, when fully extended, attachment flange 50 may reside, for example, 17 inches (43 centimeters (“cm”)) from the wall.

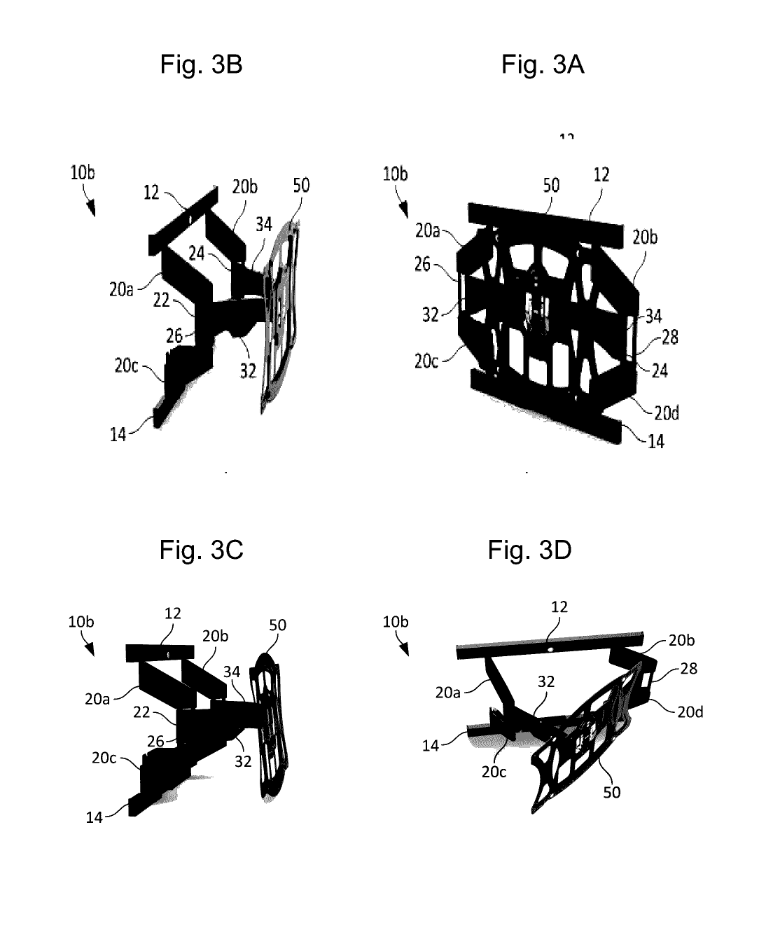

Referring now to FIGS. 3A to 3E, alternative television mount 10b is illustrated. Television mount 10b includes many of the same components as mount 10a, including top beam 12, bottom beam 14, angled members 20a to 20d, hinges 22 and 24, middle lateral members 32 and 34, hinge plate 36, and attachment flange 50. Mount 10b does not have side beams 16 and 18. Mount 10b does however have a restraining bar 26 located between angled members 20a and 20c and a restraining bar 28 located between angled members 20b and 20d. Restraining bars 26 and 28 stop angled members 20a and 20c and angled members 20b and 20d, respectfully, at a fully extended or rotated out position.

FIG. 3A shows mount 10b in a flat-use or as-packaged position. FIGS. 3B and 3C illustrate mount 10b in a fully extended, use position. FIG. 3C also shows that attachment flange 50 may be tilted up or down relative to top beam 12, bottom beam 14, and middle lateral members 32 and 34. FIGS. 3D and 3E illustrate that angled members 20a and 20c may be set at different angles than angled members 20b and 20d, while middle lateral member 32 may be set at a different angle than middle lateral member 34. Such angle adjustment allows for virtually limitless lateral mounting flexibility, which is beneficial for any type of television, especially curved televisions.

It should be appreciated at least from FIG. 3C that when mount 10b (or 10a) is in use, the rotation of each of members 20a to 20d, 32, 34 and hinge plate 36 is about a vertical axis, while the rotation of attachment flange 50 is about a horizontal axis. The arm formed by members 20a, 20c and 32 and the arm formed by members 20b, 20d and 34 may each be folded, so that the overall mount is virtually flat as illustrated by FIG. 3A. Here, a mounted television or other type of video screen resides very close to a wall or other mounting structure to which mount 10b is mounted. Or, the arm formed by members 20a, 20c and 32 and the arm formed by members 20b, 20d and 34 may each be unfolded as illustrated by FIGS. 3B and 3C. Here, a mounted television or other type of video screen is spaced out from the wall or other mounting structure to which mount 10b is mounted. FIGS. 3D and 3E illustrate that the arm formed by members 20a, 20c and 32 and the arm formed by members 20b, 20d and 34 may each be unfolded anywhere between being completely folded (FIG. 3A) and completely unfolded (FIGS. 3B and 3C) to provide a desired overall vertical tilt angle for the television or other type of video screen.

Attachment flange 50 of mounts 10a and/or 10b provides cutouts for power cords and component cabling. Again, attachment flange 50 may provide tilt head adjustment. Angled members 20a and 20c, angled members 20b and 20d, middle lateral member 32, and middle lateral member 34 may be magnetically or press-locked into a desired position. Mounts 10a and 10b may be metal, plastic or a combination thereof, and be provided with integrated cable covers if desired. Mounts 10a and 10b may have partial or complete arm assembly covers, and/or arm assembly covers that are split into multiple pieces that lock together about the internal frame members. Mounts 10a and 10b may have one or more carriage bolt for connecting Video Electronics Standards Association (“VESA”) extension wings.

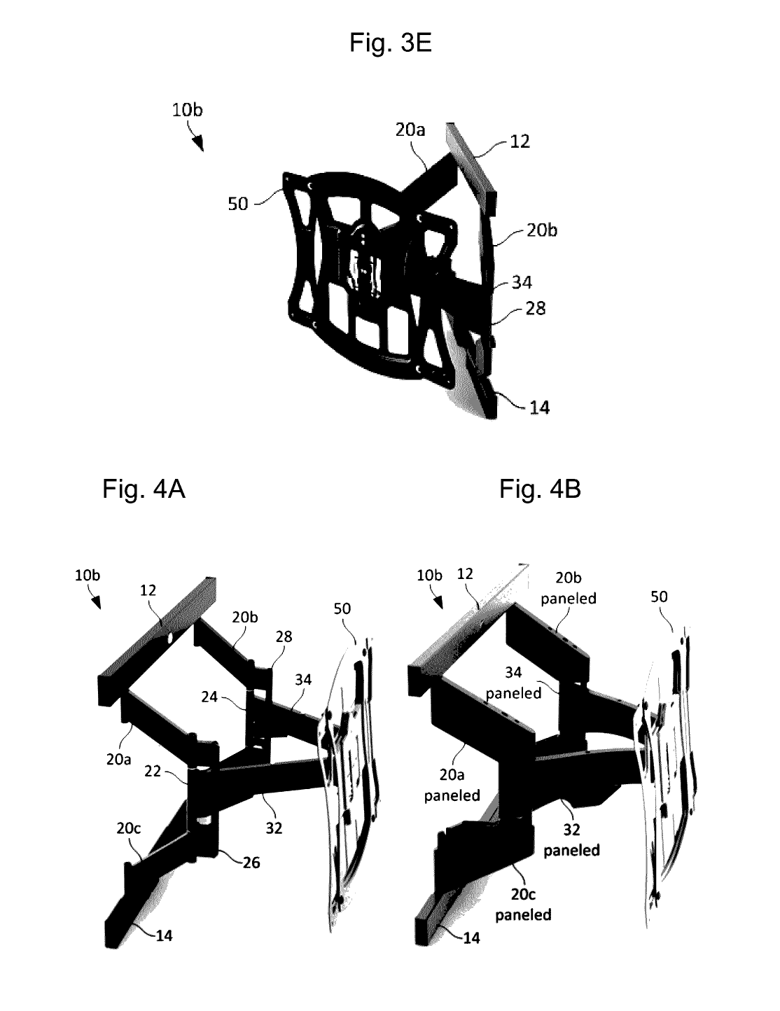

FIGS. 4A and 4B illustrate that mounts 10a and 10b can be covered in paneling, e.g., plastic or finished metal paneling. FIG. 4A illustrates example mount 10b in a skeleton state, e.g., with no paneling. FIG. 4B illustrates the same example mount 10b where angled members 20b and 20d, middle lateral member 32, and middle lateral member 34 are each covered with metal or plastic paneling. The paneling hides weld marks and/or screw or rivet connections. The paneling may have any combination of decorations, instructions, marketing materials, and/or logo-ing.

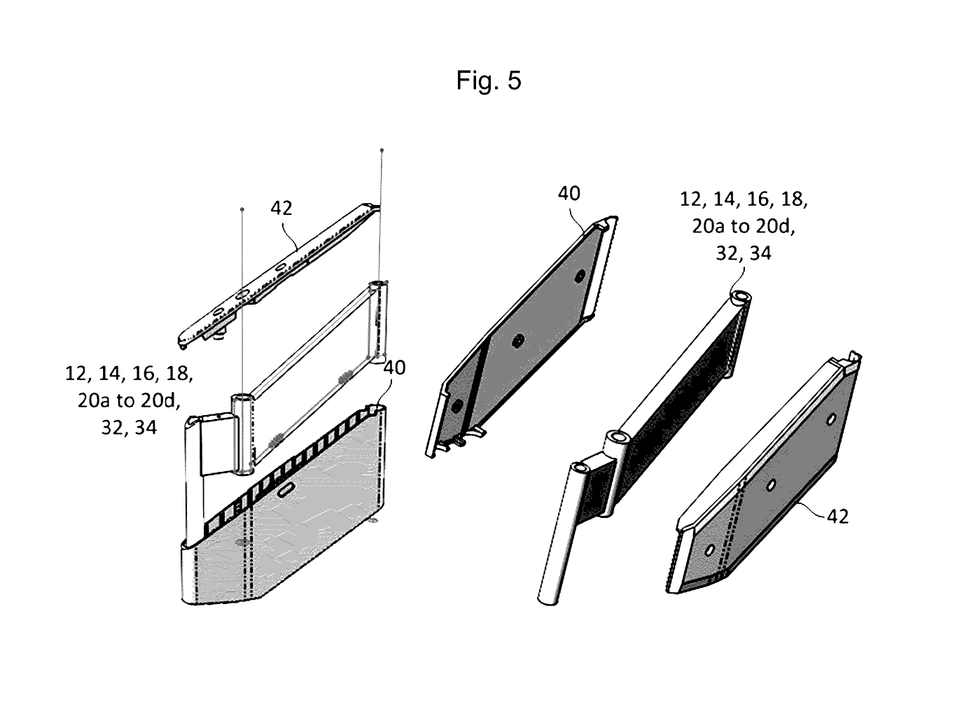

FIG. 5 illustrates one example for implementing the paneling. Panels 40 and 42 can be snap-fitted about or slid around any of top beam 12, bottom beam 14, side beams 16 and 18, angled members 20a to 20d, middle lateral member 32, and/or middle lateral member 34.

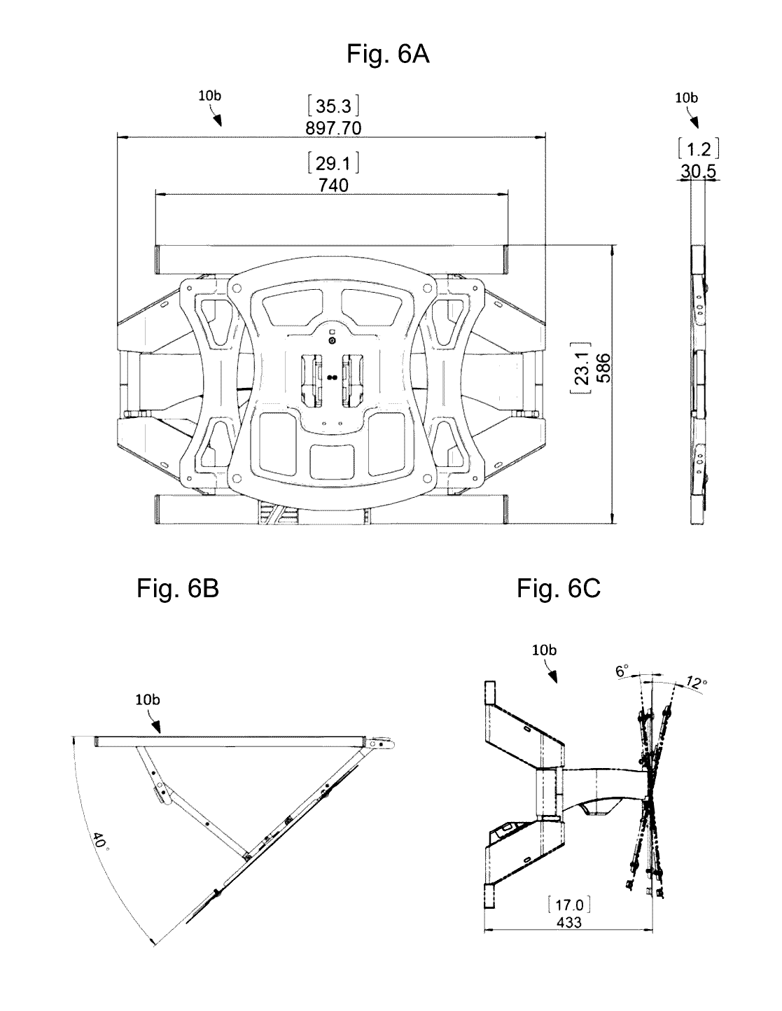

FIGS. 6A to 6C provide one example of dimensions and angular movement ranges for mounts 10a and/or 10b of the present disclosure. The dimensions and angular movement are for illustrative purposes only and may be modified as desired to make larger, smaller, and more or less movement restricted mounts. Moreover, multiple attachment flanges 50 may be provided (one used at a time) to accommodate differently sized television or other video screen hole patterns or footprints. Each attachment flange 50 may also have sliding panels or the like to provide variability to accommodate differently sized television or other video screen hole patterns or footprints.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A mount for televisions and the like comprising:
a first beam;
a second beam;
plural first members connected rotatably to the first beam;
plural second members connected rotatably to the second beam;
a third member connected rotatably to a first pair of the first and second members;
a fourth member connected rotatably to a second pair of the first and second members; and
a plate connected rotatably to the third and fourth members.

2. The mount of claim 1, wherein at least one of the rotatable connections is a hinged connection.

3. The mount of claim 1, wherein at least one of the members is covered with a panel.

4. The mount of claim 1, which includes an attachment flange connected to the plate, the attachment flange providing at least one hole for attachment to the television or the like.

5. The mount of claim 4, which includes differently sized attachment flanges for differently sized televisions and the like.

6. The mount of claim 4, wherein the attachment flange is connected rotatably to the plate.

7. The mount of claim 6, wherein when the mount is in use, the rotatable connections of the first, second, third and fourth members and the plate are about at least substantially vertical axes, while the rotatable connection of the attachment flange is about an at least substantially horizontal axis.

8. The mount of claim 1, which includes a first hinge rod extending between the first and second members of the first pair, the third member connected to the first hinge rod, the first hinge rod rotatable with respect to the first and second members.

9. The mount of claim 8, which further includes a restraining member for restraining movement of the third member, the restraining member extending between the first and second members of the first pair.

10. The mount of claim 8, which includes a second hinge rod extending between the first and second members of the second pair, the fourth member connected to the second hinge rod, the second hinge rod rotatable with respect to the second pair of the first and second members.

11. The mount of claim 1, which includes at least one support beam extending between the first and second beams.

12. The mount of claim 1, wherein when the mount is in use, the plural first members angle downwardly from the first beam.

13. The mount of claim 12, wherein when the mount is in use, the plural second members angle upwardly from the second beam.

14. The mount of claim 13, wherein the angles provided by the plural first members and the plural second members place the third and fourth members at least substantially equally between the first and second beams.
A mount for televisions and the like comprising:
a first beam;
a second beam;
a first member connected rotatably to the first beam and angled towards the second beam;
a second member connected rotatably to the second beam and angled towards the first beam;
a third member connected rotatably to the first and second members, the angles of the first and second members placing the third member at least substantially equally between the first and second beams; and
a plate connected rotatably to the third member.

15. The mount of claim 15, which includes an attachment flange connected to the plate, the attachment flange providing at least one hole for attachment to the television or the like.

16. The mount of claim 15, which includes at least one support beam extending between the first and second beams.

17. The mount of claim 15, which includes a hinge rod extending between the first and second members, the third member connected to the hinge rod, the hinge rod rotatable with respect to the first and second members.

18. The mount of claim 18, which further includes a restraining member for restraining movement of the third member, the restraining member extending between the first and second members.

19. A mount for televisions and the like comprising:
a first beam;
a second beam;
a plate;
a first arm in rotatable communication with (i) the first and second beams and (ii) the plate, the first arm including a first internal hinge; and
a second arm in rotatable communication with (i) the first and second beams and (ii) the plate, the second arm including a second internal hinge.
